(19) United States
(12) Patent Application Publication
(10) Pub. No.: US 2011/0032276 A1
(43) Pub. Date: Feb. 10, 2011

(54) ELECTROWETTING DISPLAY DEVICE AND DRIVING METHOD FOR DISPLAY DEVICE

(76) Inventors: Yi-Cheng CHEN, Taoyuan County (TW); Yung-Hsiang CHIU, Miaoli County (TW); Wei-Yen LEE, Taichung County (TW)

Correspondence Address: BIRCH STEWART KOLASCH & BIRCH, PO BOX 747, FALLS CHURCH, VA, 22040-0747, US

(21) Appl. No.: 12/579,170

(22) Filed: Oct. 14, 2009

(30) Foreign Application Priority Data
Aug. 5, 2009 (TW) 098126335

(51) Int. Cl. G09G 5/10

(52) U.S. Cl. 345/690

(57) ABSTRACT

An electrowetting display device and a driving method for a display device are provided. The electrowetting display device includes at least a pixel unit, a first driver and a second driver. The pixel unit includes at least a switch, at least a storage capacitor and at least an electrowetting pixel element. The switch is coupled between a node and a data line, and the switch has a control terminal coupled to a scan line. The storage capacitor is coupled between the node and a first common node. The electrowetting pixel element is coupled between the node and a second common node. The first driver provides a pulse signal to the control terminal of the switch via the scan line to turn on the switch. The second driver provides a gray scale signal to the electrowetting pixel element via the data line when the switch is turned on.

### CROSS REFERENCE TO RELATED APPLICATIONS

This Application claims priority of Taiwan Patent Application No. 098126335, filed on Aug. 5, 2009, the entirety of which is incorporated by reference herein.

### BACKGROUND

1. Technical Field

The disclosure relates to a display device, and more particularly to an electrowetting display device and a driving method for a display device.

2. Description of Disclosure

Electrowetting display devices render images in accordance with electrowetting or electrocapillary processes. Basically, free surface energy (distribution area) of fluids is changed when an electric field is applied thereto.

WO 2005/036517 discloses an electrowetting display device. The electrowetting display device provides a series of pulses prior to a fixed gray level voltage to the electrowetting pixel element, so as to improve gray level accuracy and stability. WO 2009/004042 discloses an electrowetting system with a digital to analog converter, which provides different gray level voltages to electrowetting pixel elements via switches, so as to decrease power consumption for the system.

The electrowetting display devices disclosed use hydrophobic and hydrophilic solvents (such as oil and water) in pixels as part of the display structure. Bias is exerted on the electrode beneath the water layer and the hydrophobic dielectric layer, resulting in voltage differences which shrink oil ink droplets due to electrowetting phenomenon. Moreover, the contraction rate of oil ink is controlled by exerting different voltages, thereby producing grayscale effect required for high-quality displays. FIG. 1A shows a cross section illustrating a dark state of an electrowetting pixel element 10, and FIG. 1B shows a cross section illustrating a bright state of the electrowetting pixel element 10. The electrowetting pixel element 10 comprises a transparent polar fluid 11 (ex. water), an opaque non-polar fluid 12 (ex. ink), ribs 13, a hydrophobic layer 14 and a reflective layer 16. When no voltage is applied to the electrowetting pixel element 10, the ink 12 is uniformly distributed at the surface of the hydrophobic layer 14. Thus, an incident-light 18 is absorbed by the ink 12 such that the dark state is rendered on the electrowetting pixel element 10, as shown in FIG. 1A. On the contrary, when a voltage is applied to the electrowetting pixel element 10, the ink 12 contracts. Therefore, the incident light 18 is reflected through the reflective layer 16 (ex. a reflected light 19) such that the bright state is rendered on the electrowetting pixel element 10, as shown in FIG. 1B.

However, due to an interfacial tension between the ink 12 and the hydrophobic layer 14, the applied voltage must be higher than a threshold voltage so as to contract the ink 12, wherein the threshold voltage is influenced by the panel specification or ink thickness and viscosity. For example, the threshold voltage is increased when the panel size is decreased or the ink thickness is increased.

### SUMMARY

An electrowetting display device and a driving method for a display device are provided. An exemplary embodiment of an electrowetting display device is provided. The electrowetting display device comprises at least a pixel unit, a first driver and a second driver. The pixel unit comprises at least a switch coupled between a node and a data line, at least a storage capacitor coupled between the node and a first common node, and at least an electrowetting pixel element coupled between the node and a second common node. The switch has a control terminal coupled to a scan line. The first common node and the second common node are used to receive different signals, respectively. The first driver provides a pulse signal to the control terminal of the switch via the scan line to turn on the switch. The second driver provides a gray scale signal to the electrowetting pixel element via the data line when the switch is turned on.

Furthermore, an exemplary embodiment of a driving method for a display device is provided, wherein the display device comprises a switch, a storage capacitor coupled between the switch and a first common node, and a pixel element coupled between the switch and a second common node. A reference signal with a fixed voltage level is provided to the storage capacitor via the first common node. A threshold signal is provided to the pixel element via the second common node, wherein a voltage level of the threshold signal is different from that of the fixed voltage level. When the switch is turned on, a gray scale signal is provided to the pixel element.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1A shows a cross section illustrating a dark state of an electrowetting pixel element, and FIG. 1B shows a cross section illustrating a bright state of the electrowetting pixel element;

FIG. 2 shows an electrowetting display device according to an embodiment of the invention;

FIG. 3 shows a pixel unit according to an embodiment of the invention;

FIG. 4 shows a waveform diagram illustrating the signals of a pixel unit according to an embodiment of the invention;

FIG. 5 and FIG. 6 show the waveform diagrams illustrating the signals of a pixel unit according to an embodiment of the invention, respectively.

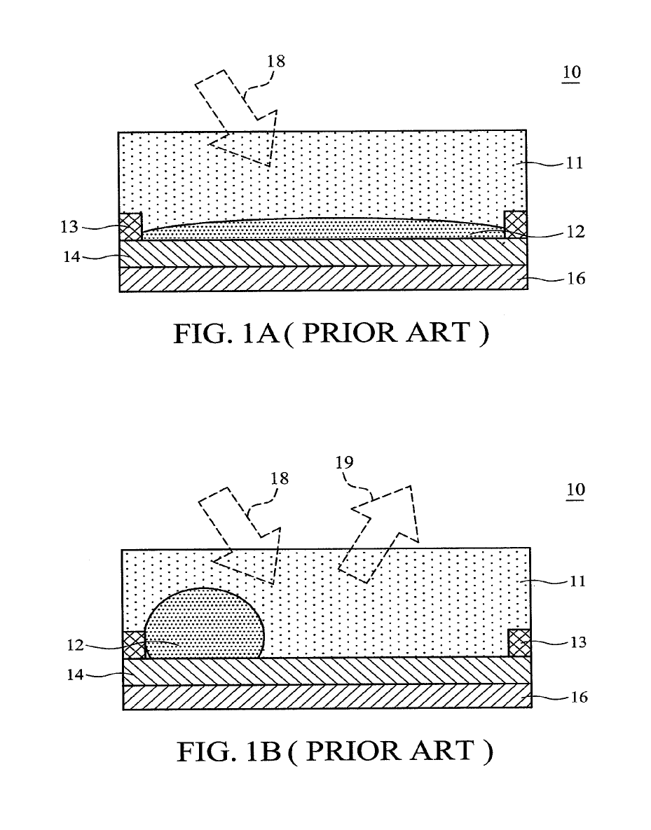

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

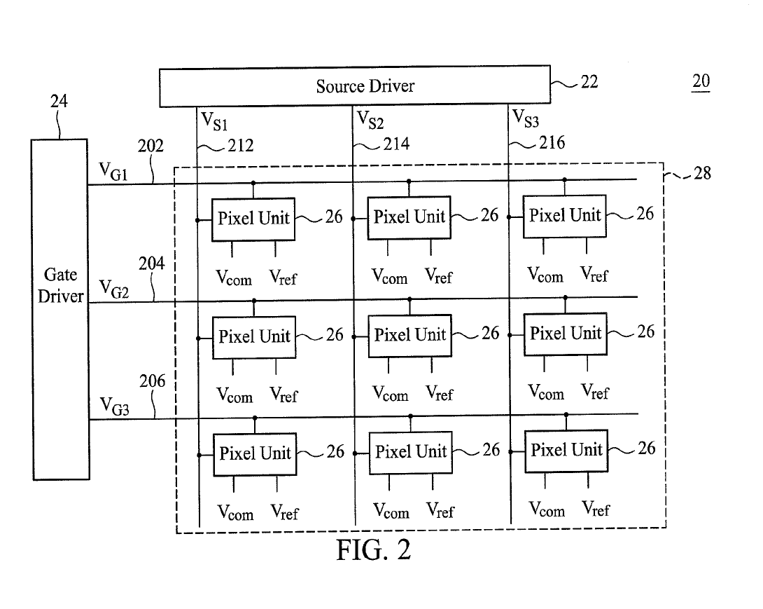

FIG. 2 shows an electrowetting display device 20 according to an embodiment of the invention. The electrowetting display device 20 comprises a source driver 22, a gate driver 24 and a pixel array 28, wherein the pixel array 28 comprises a plurality of pixel units 26. In FIG. 2, the source driver 22 provides the gray scale signals V_{S1}, V_{S2} and V_{S3} to the pixel units 26 disposed in the same column via the signal lines 212, 214 and 216 (data lines), respectively, and the gate driver 24 provides the scan signals V_{G1}, V_{G2} and V_{G3} to the pixel units 26 disposed in the same row via the signal lines 202, 204 and 206 (scan lines), respectively.

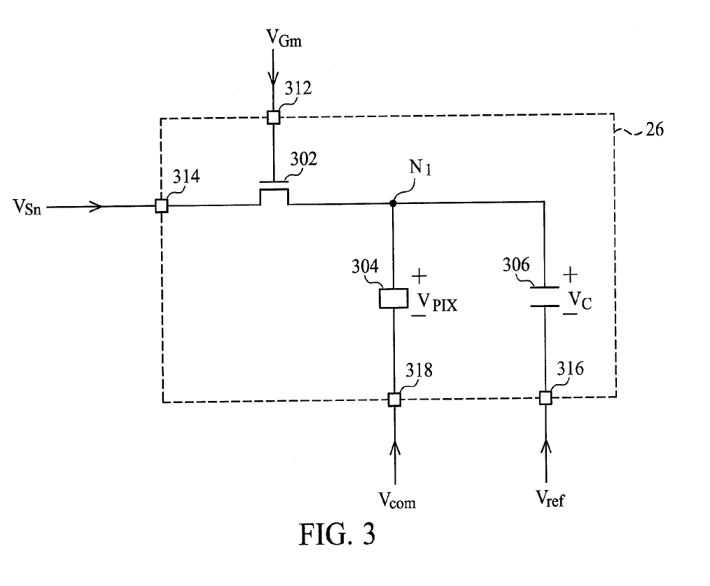

FIG. 3 shows the pixel unit 26 according to an embodiment of the invention. The pixel unit 26 comprises a switch 302, a pixel element 304 and a storage capacitor 306. The switch 302 is coupled between an input terminal 314 and a node N₁, and a control terminal of the switch 302 is coupled to an input terminal 312. The pixel element 304 is coupled between the node N₁ and an input terminal 318, and the storage capacitor 306 is coupled between the node N₁ and an input terminal 316. Referring to FIG. 2 and FIG. 3 together, the source driver 22 provides a gray scale signal V_{Sn}, to the input terminal 314 via the n^{th} data line, and the gate driver 24 provides a scan signal V_{Gm} to the input terminal 312 via the m^{th} scan line, wherein n and m represent that the pixel unit 26 is disposed in the n^{th} column and the m^{th} row of the pixel array 28. It is to be noted that the disposition of the source driver 22, the gate driver 24 and the pixel array 28 is determined according to the specification and application of the displays. In the pixel array 28, the input terminal 316 of each pixel unit 26 is connected together, i.e. the input terminal 316 of each pixel unit 26 is referred to as a first common node. The first common node 316 is used to receive a reference signal V_{ref}, wherein the reference signal V_{ref} is a signal with a fixed voltage level that functions as a reference potential of the storage capacitor 306. Therefore, a voltage of the gray scale signal V_{Sn} is stored into the storage capacitor 306 when the switch 302 is turned on by the scan signal V_{Gm}, wherein the gray scale signal V_{Sn} is a driving voltage for controlling a contraction ratio of ink. In addition, the input terminal 318 of each pixel unit 26 is connected together, i.e. the input terminal 318 of each pixel unit 26 is referred to as a second common node. The second common node 318 is used to receive a threshold signal V_{com} which may provide a threshold voltage for ink contraction. In the embodiment, the waveform and voltage level of the threshold signal V_{com} are unrelated to the reference signal V_{ref}, i.e. the threshold signal V_{com} and the reference signal V_{ref} are different signals. Furthermore, the switch 302 is a thin film transistor (TFT) and the pixel element 304 is an electrowetting pixel element.

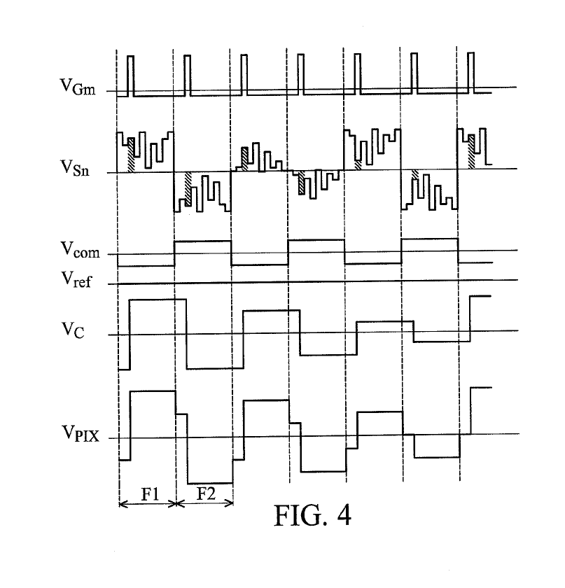

FIG. 4 shows a waveform diagram illustrating the signals of a pixel unit according to an embodiment of the invention. Referring to FIG. 3 and FIG. 4 together, a signal V_{C} represents a voltage stored in the storage capacitor 306, and a signal V_{PIX} represents a voltage applied to the pixel element 304. First, in a first scan period F1, the switch 302 is turned on when the scan signal V_{Gm} is at a high voltage level. Simultaneously, the driving voltage (oblique area) provided by the gray scale signal V_{Sn} is stored into the storage capacitor 306, as shown in the signal V_{C}. The threshold signal V_{com} is a threshold driving voltage of the pixel element 304, wherein a voltage difference between the threshold signal V_{com} and the signal V_{C} is a voltage across the pixel element 304, as shown in the signal V_{PIX}. In the first scan period F1, the gray scale signal V_{Sn} is a positive polarity voltage that is larger than 0V, and the threshold signal V_{com} is a negative polarity voltage that is smaller than 0V. In a second scan period F2, the gray scale signal V_{Sn} is a negative polarity voltage, and the threshold signal V_{com} is a positive polarity voltage. Therefore, the gray scale signal V_{Sn} and the threshold signal V_{com} have different voltage polarities. Furthermore, in the two adjacent scan periods, the voltage polarities of the gray scale signal V_{Sn} and the threshold signal V_{com} may also be alternated, respectively, thus avoiding charge accumulation for the storage capacitor 306 and the pixel element 304. Moreover, compared with the gray scale signal V_{Sn}, the threshold signal V_{com} is a low frequency periodic signal, the voltage of the threshold signal V_{com} is different from that of the reference signal V_{ref},

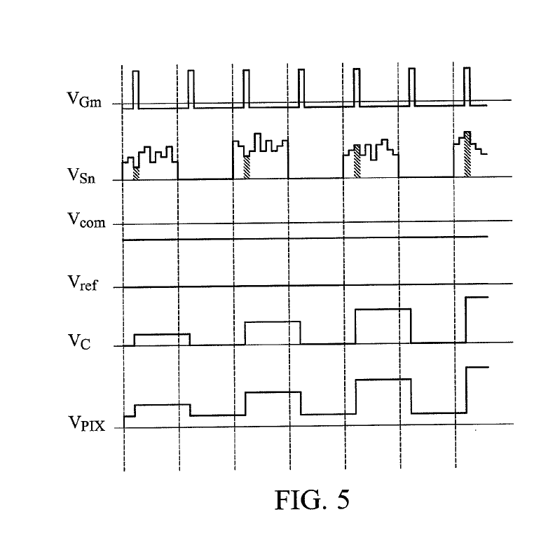

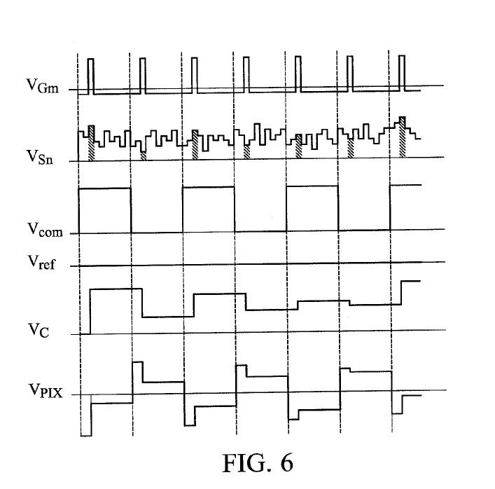

FIG. 5 and FIG. 6 show the waveform diagrams illustrating the signals of a pixel unit according to an embodiment of the invention, respectively. As described above, the signal V_{C} represents the voltage stored in the storage capacitor 306, and the signal V_{PIX} represents the voltage applied to the pixel element 304. Referring to FIG. 5, the threshold signal V_{com} is a direct current (DC) signal, wherein the voltage level of the threshold signal V_{com} is different than the reference signal V_{ref}. In addition, in one embodiment, the voltage level of the threshold signal V_{com} is identical to the reference signal V_{ref}. Referring to FIG. 6, the voltage polarities of the gray scale signal V_{Sn} and the threshold signal V_{com} may not be alternated. Furthermore, in one embodiment, the gray scale signal V_{Sn} and the threshold signal V_{com} have the same voltage polarities.

Any display device (i.e. electrowetting, electrophoretic or liquid crystal type display device with different pixel sizes or types) may correct process variations by controlling the threshold signal of the pixel elements according to the invention. Furthermore, the gray scale signal is directly provided by the source driver.

While the invention has been described by way of example and in terms of embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electrowetting display device, comprising:
at least a pixel unit, comprising:
at least a switch coupled between a node and a data line, having a control terminal coupled to a scan line;
at least a storage capacitor coupled between the node and a first common node; and
at least an electrowetting pixel element coupled between the node and a second common node, wherein the first common node and the second common node are used to receive different signals, respectively;
a first driver, providing a pulse signal to the control terminal of the switch via the scan line to turn on the switch; and
a second driver, providing a gray scale signal to the electrowetting pixel element via the data line when the switch is turned on.

2. The electrowetting display device as claimed in claim 1, wherein the first common node is used to receive a reference signal with a fixed voltage level, and the second common node is used to receive a threshold signal different from the reference signal.

3. The electrowetting display device as claimed in claim 2, wherein the threshold signal is a low frequency periodic signal or a direct current signal.

4. The electrowetting display device as claimed in claim 1, wherein the switch is a thin film transistor.

5. The electrowetting display device as claimed in claim 1, wherein the first common node is used to receive a reference signal with a fixed voltage level, and the second common node is used to receive a threshold signal.

6. The electrowetting display device as claimed in claim 5, wherein a voltage level of the threshold signal is different from the fixed voltage level.

7. The electrowetting display device as claimed in claim 5, wherein a voltage level of the threshold signal is identical to the fixed voltage level.

8. The electrowetting display device as claimed in claim 5, wherein the gray scale signal and the threshold signal have different voltage polarities.

9. The electrowetting display device as claimed in claim 5, wherein the gray scale signal and the threshold signal have the same voltage polarities.

10. The electrowetting display device as claimed in claim 5, wherein a voltage across the electrowetting pixel element is a voltage difference between a voltage of the storage capacitor and the threshold signal when the switch is turned on.

11. A driving method for a display device, wherein the display device comprises a switch, a storage capacitor coupled between the switch and a first common node, and a pixel element coupled between the switch and a second common node, comprising:
providing a reference signal with a fixed voltage level to the storage capacitor via the first common node;
providing a threshold signal to the pixel element via the second common node, wherein a voltage level of the threshold signal is different from the fixed voltage level;
turning on the switch; and
providing a gray scale signal to the pixel element when the switch is turned on.

12. The driving method as claimed in claim 11, wherein the threshold signal is a low frequency periodic signal or a direct current signal.

13. The driving method as claimed in claim 11, wherein the switch is a thin film transistor.

14. The driving method as claimed in claim 11, wherein the display device further comprises:
a first driver, providing a pulse signal to the switch to turn on the switch; and
a second driver, providing the gray scale signal.

15. The driving method as claimed in claim 11, wherein the gray scale signal and the threshold signal have different voltage polarities

16. The driving method as claimed in claim 11, wherein the gray scale signal and the threshold signal have the same voltage polarities.

17. The driving method as claimed in claim 11, wherein a voltage across the pixel element is a voltage difference between a voltage of the storage capacitor and the threshold signal when the switch is turned on.

18. The driving method as claimed in claim 11, wherein the display device is an active matrix display.

19. The driving method as claimed in claim 18, wherein the display device is an electrowetting display, an electrophoretic display or a liquid crystal display.
